(19) United States
(12) Patent Application Publication
(10) Pub. No.: US 2001/0027417 A1
(43) Pub. Date: Oct. 4, 2001

(54) Method of providing information and system using the method

(76) Inventor: Takashi Sato, Sappori-shi (JP)

Correspondence Address: McGLEW AND TUTTLE, SCARBOROUGH STATION, SCARBOROUGH, NY, 10510-0827, US

(21) Appl. No.: 09/821,589

(22) Filed: Mar. 29, 2001

(30) Foreign Application Priority Data
Mar. 30, 2000 (JP) 2000-94510
Feb. 28, 2001 (JP) 2001-55409

(51) Int. Cl. G06F 17/60

(52) U.S. Cl. 705/14

(57) ABSTRACT

A method of providing information and a system using the method are provided which provide advertisements of one or a plurality of corporations including non-profit organizations and also provide quizzes corresponding to the provided advertisements of the corporations, and further provide predetermined services to contestants of a quiz contest, thereby making it possible to obtain sufficient effects of advertisements on a network. The method of providing information is the method of providing information on commodities, services and advertisements using a plurality of computers connected to the network, wherein a computer of a party providing advertisements provides advertisements to one or a plurality of corporations and also provides quizzes corresponding to the advertisements of the corporations, and on the other hand, a terminal of a party receiving information on commodities, services and advertisements inputs answers to the quizzes and also inputs an identification number for identifying a contestant in the computer of a party providing advertisements.

### BACKGROUND OF THE INVENTION

1. Field of the Invention

The present invention relates to a method of providing information on commodities, services, advertisements and the like on a network (computer network) and a system for providing information using this method and, in particular, to a method and a system for providing information that provide quizzes together with the information.

2. Description of the Related Art

Conventional situation of providing information on commodities, services, advertisements and the like on the Internet is as follows:

1. There is no content and program only for quizzes.

2. Although a “quiz corner” is simply provided in a home page (content) of a company (organization), quizzes are not used as motivations and for the purpose of conducting marketing.

3. There is no program that makes good use of quizzes in conducting various marketing such as sales promotions and new product developments on the Internet.

4. A quiz program is not utilized as means for improving celebrity and an image of an individual (e.g., an entertainer and a candidate of an election), or the like.

5. A local self-governing body and an organization do not use a business method that uses quizzes for vitalizing local economies, attracting tourists, promoting sales of special products, or the like.

6. There is no content and program only for quizzes which periodically provide quizzes (particularly in a short term).

7. There is no special marketing plan that uses quizzes and prizes as tools.

8. Quizzes are not used as an entertainment or for medical and health purposes in spite of the fact that quizzes vitalize brains of people in the specific age brackets (the aged, children, infants). Thus, there are few monitors of advanced ages.

9. Consumer layers that have no interest in the Internet cannot be attracted.

10. The Internet is not utilized by people belonging to wide age brackets such as the aged and children.

Since the conventional situation of providing information on commodities, services, advertisement and the like is as described above, there are problems such as the following.

1. Since quizzes are provided on a home page of a company (or an organization, an individual), varieties of prizes provided by those who prepared the quizzes are limited, and users of the Internet cannot select a desired prize from a wide range of items. Therefore, the prizes themselves are unattractive, and as a result, the number of accesses becomes relatively few. Thus, sufficient effects of advertisements cannot be expected.

2. Since a variety of quizzes cannot be selected on one home page, interests of users of the Internet decline, and as a result, the number of accesses for answering quizzes becomes relatively few. Thus, sufficient effects of advertisements cannot be expected.

### SUMMARY OF THE INVENTION

The present invention has been devised in view of the above and other drawbacks, and it is an object of the present invention to provide a method of providing information and a system for providing information using this method which set a content and a program for providing information on advertisements and information on commodities and services together with simultaneously providing quizzes, provide advertisements of one or a plurality of corporations including non-profit organizations and also provide quizzes corresponding to the provided advertisements of the corporations on the content and the program, and further provide predetermined services to contestants of a quiz contest.

It is another object of the present invention to provide a method of providing information and a system for providing information which can establish a database of precise user information by providing questionnaires together with quizzes and collecting answers to them, and further improve effects of advertisements using the user information.

A method of providing information in accordance with a first aspect of the present invention is a method of providing information with which a computer of a party providing information on commodities, services, advertisements and the like and a plurality of terminals of parties receiving information on commodities, services, advertisements and the like are connected to a network, and the computer of a party providing information provides information on commodities, services, advertisements and the like to the terminals of parties receiving information over the network, characterized in that the computer of a party providing information provides advertisements of one or a plurality of corporations and also provides quizzes corresponding to the advertisements of the corporations, and the terminals of parties receiving information input answers to the quizzes provided by the computer of a party providing information and also input identification numbers for distinguishing contestants.

A method of providing information in accordance with a second aspect of the present invention is characterized in that the corporations include non-profit organizations.

A method of providing information in accordance with a third aspect of the present invention is characterized in that the non-profit organizations include local self-governing bodies.

A method of providing information in accordance with a fourth aspect of the present invention is characterized in that the computer of a party providing information notifies the terminals of parties receiving information whether the answers to the quizzes are correct or not.

A method of providing information in accordance with a fifth aspect of the present invention is characterized in that the computer of a party providing information provides information relating to the answers to the quizzes to the terminals of parties receiving information.

A method of providing information in accordance with a sixth aspect of the present invention is characterized in that the information relating to the answers to the quizzes includes information on commodities, services, advertisements and the like relating to advertisements that the contestants of the quizzes saw.

A method of providing information in accordance with a seventh aspect of the present invention is characterized in that the computer of a party providing information provides the quizzes and, at the same time, provides a questionnaire to the terminals of parties receiving information, and collects answers to the questionnaire.

A method of providing information in accordance with an eighth aspect of the present invention is characterized in that, in the questionnaire, first quizzes are provided when the terminals of parties receiving information access the computer of a party providing information, second quizzes are provided when advertisements provided by the computer of a party providing information are clicked on the terminals of parties receiving information, third quizzes are provided when the terminals of parties receiving information enter a contest for prizes provided by the computer of a party providing information, and the computer of a party providing information thus collects answers to respective items of the questionnaire.

A method of providing information in accordance with a ninth aspect of the present invention is characterized in that the computer of a party providing information performs predetermined data analysis based on the collected answers to the questionnaire.

A method of providing information in accordance with a tenth aspect of the present invention is characterized in that the terminals are computers.

A method of providing information in accordance with an eleventh aspect of the present invention is characterized in that the terminals are cellular phones.

A system for providing information in accordance with a twelfth aspect of the present invention is a system for providing information with which a computer of a party providing information on commodities, services, advertisements and the like and a plurality of terminals of parties receiving information on commodities, services, advertisements and the like are connected to a network, and the computer of a party providing information provides information on commodities, services, advertisements and the like to the terminals of parties receiving information on the network, which is characterized in that the computer of a party providing information is provided with fifth means for providing advertisements of one or a plurality of corporations and sixth means for providing quizzes corresponding to the advertisements of the corporations.

A system for providing information in accordance with a thirteenth aspect of the present invention is characterized in that the corporations include non-profit organizations.

A system for providing information in accordance with a fourteenth aspect of the present invention is characterized in that the non-profit organizations include local self-governing bodies.

A system for providing information in accordance with a fifteenth aspect of the present invention is characterized in that the computer of a party providing information is provided with seventh means for notifying the terminals of parties receiving information whether the answers to the quizzes are correct or not.

A system for providing information in accordance with a sixteenth aspect of the present invention is characterized in that the computer of a party providing information is provided with eighth means for notifying information relating to the answers to the quizzes to the terminals of parties receiving information.

A system for providing information in accordance with a seventeenth aspect of the present invention is characterized in that the information relating to the answers to the quizzes includes information on commodities, services, advertisements and the like relating to advertisements that the contestants of the quizzes saw.

A system for providing information in accordance with an eighteenth aspect of the present invention is characterized in that the computer of a party providing information is provided with ninth means for providing the quizzes and, at the same time, providing a questionnaire to the terminals of parties receiving information, and collecting answers to the questionnaire.

A system for providing information in accordance with a nineteenth aspect of the present invention is characterized in that, with the ninth means, first quizzes are provided when the terminals of parties receiving information access the computer of a party providing information, second quizzes are provided when advertisements provided by the computer of a party providing information are clicked on the terminals of parties receiving information, third quizzes are provided when the terminals of parties receiving information enter a contest for prizes provided by the computer of a party providing information, and the computer of a party providing information thus collects answers to respective items of the questionnaire.

A system for providing information in accordance with a twentieth aspect of the present invention is characterized in that the computer of a party providing information is provided with tenth means for performing predetermined data analysis based on the collected answers to the questionnaire.

A system for providing information in accordance with a twenty-first aspect of the present invention is characterized in that the terminals are computers.

A system for providing information in accordance with a twenty-second aspect of the present invention is characterized in that the terminals are cellular phones.

### BRIEF DESCRIPTION OF THE DRAWINGS

In the accompanying drawings:

FIG. 1 is a block diagram showing a system for providing information according to an embodiment of the present invention;

FIG. 2 is a flow chart showing procedures for providing information according to a method of providing information of the present invention;

FIG. 3 is a block diagram showing a system for providing information according to another embodiment of the present invention;

FIG. 4 is a flow chart showing procedures from the stage of pre-questionnaires to the stage of answering questionnaires according to the present invention; and

FIG. 5 is a block diagram showing a system for providing information according to still another embodiment of the present invention.

### DETAILED DESCRIPTION OF THE PREFERRED EMBODIMENTS

In the following discussion of the preferred embodiments of the present invention, reference is made to the accompanying drawings. Like reference numerals used through out the several figures refer to like or corresponding parts.

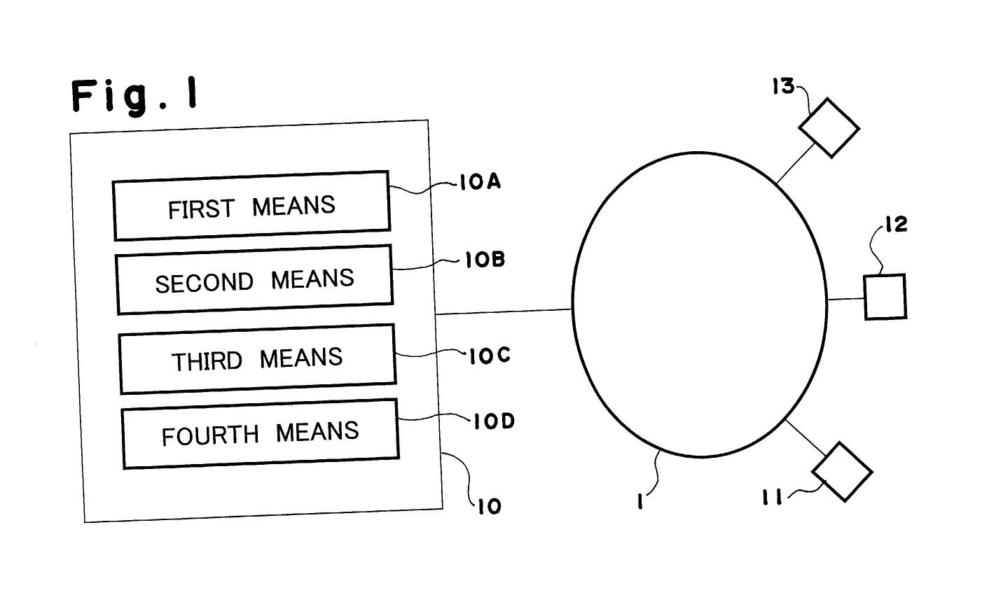

An embodiment of the present invention will be described with reference to the drawings. FIG. 1 is a block diagram showing a system for providing information on advertisements according to the present invention. A computer 10 of a party providing advertisement as well as computers 11, 12 and 13 that are terminals of parties receiving information on advertisements from the computer 10 are connected to a network 1.

The computer 10 of a party providing advertisement is provided with advertisement providing means 10A as first means for providing advertisements of a plurality of corporations, quiz providing means 10B as second means for providing quizzes relating to the advertisements of the corporations, true-false notifying means 10C as third means for notifying, for example, the computer 11 of a party receiving information on advertisements whether answers to the quizzes are correct or not, and quiz answer related information notifying means 10D as fourth means for notifying the computer 11 of information relating to the answers to the quizzes.

Further, the above-mentioned information relating to the answers to the quizzes includes information on presentation of prizes or grant of points and information on advertisements that a contestant saw, for example, information on a new commodity if the answers are correct at a high percentage. Each of these pieces of information is transmitted to the computer 11 of a party receiving information on advertisements from the computer 10 of a party providing advertisement using a mail address or the like. In addition, the corporations include non-profit organizations, which include local self-governing bodies.

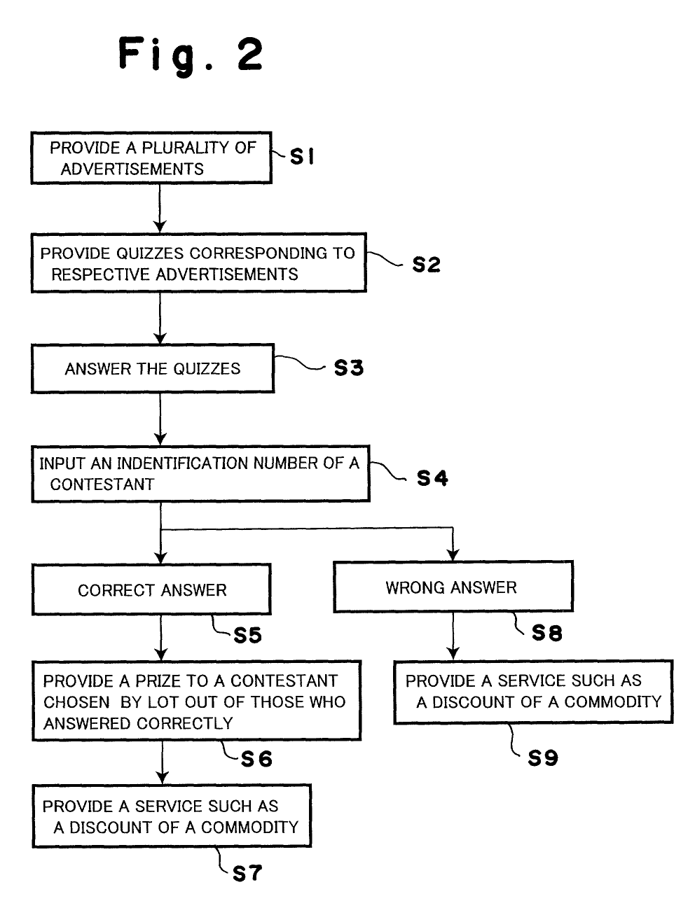

Further, as shown in FIG. 2, in the system for providing information on advertisements, the computer 10 of a party providing advertisements provides advertisements of a plurality of corporations (step S1) and also provides quizzes corresponding to the advertisements of the corporations (step S2). The computer 11 of a party receiving information on advertisements inputs answers of the quizzes (step S3), and at the same time, inputs an identification number of a contestant in the computer 10 of a party providing advertisements (step S4). Moreover, the computer 10 of a party providing advertisement notifies the computer 11 of a party receiving information on advertisements whether the answers to the quizzes are correct or not (steps S5 and SB) and also notifies it of information relating to the answers of the quizzes (steps S6, S7 and S9).

That is, in the present invention, a content provider places a home page only for quizzes from an advertisement provider on the Internet to make advertisements of the advertisement provider browsable and provides a quiz program corresponding to the advertisements. Thus, the content provider can support marketing activities conducted by the advertisement provider. Therefore, the provider of the home page can collect a predetermined amount of an advertisement fee from the advertisement provider.

Further, a prize of a quiz is provided to a person chosen by lot out of those who answered correctly (step S6). A service such as a discount of a commodity is provided to those who were not chosen by lot (step S7). The computer 11 of a party receiving information on advertisements is notified of this information by the computer 10 of a party providing advertisements. The advertisement provider includes a corporation, an organization, an individual and the like in addition to a local self-governing body. A qualification for answering quizzes may be given only to those who have been registered as members or may be given to anybody without requiring a member registration.

In addition, a person who answers quizzes is required to input predetermined answer data to which an identification number (ID) of the contestant is attached. More specifically, the contestant inputs his/her address, name, age, sex, occupation and the like in addition to his/her e-mail address. This kind of system for providing information makes it possible to provide information on advertisements that is deemed to be necessary even later to the computer 11 of a party receiving information on advertisements from the computer 10 of a party providing advertisements. Contents of quizzes are revised at a predetermined interval, and forms of quizzes may be determined as any one of a choosing type, a writing type, a filling type and the like.

If a free writing space is provided on a quiz answer page, in which contestants are asked to write opinions or impressions as they wish, opinions from wider layers of consumers can be obtained. If objects of quiz contestants are limited, a detailed market research is possible as well. In addition, in order to make contents of the page more vitalized and well-known, it may also be effective to commend a contestant who has made correct answers most in a year and notify quiz contestants of this information, or to send information on advertisements relating to quiz answers by e-mails. For example, it may also be effective to give points to a contestant depending on the number of times the contestant makes correct answers, and when the point reaches a fixed number, notify the contestant accordingly to send a prize.

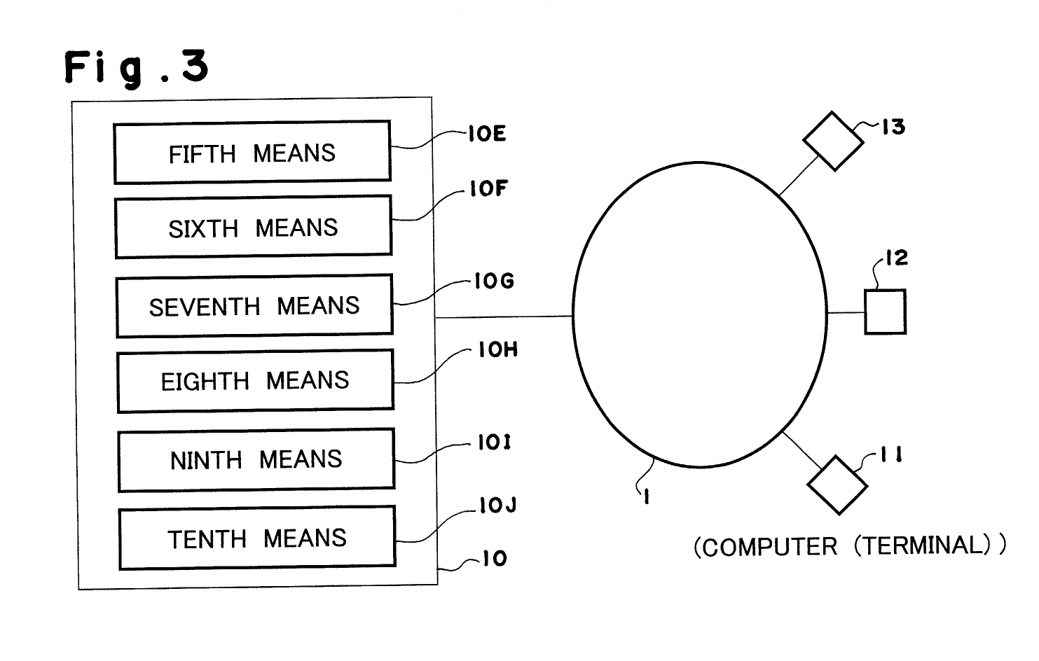

FIG. 3 is a block diagram showing a system for providing information on commodities, services and advertisements according to another embodiment of the present invention. In this figure, the computer 10 of a party providing advertisement as well as the computers 11, 12 and 13 that are terminals of parties receiving information on commodities, services and advertisements from the computer 10 are connected to the network 1.

The computer 10 is provided with advertisement providing means 10E as fifth means for providing advertisements of one or a plurality of corporations, quiz providing means 10F as sixth means for providing quizzes relating to commodities, services and advertisements of the corporations, true-false notifying means 10G as seventh means for notifying, for example, the computer 11 receiving each piece of information on commodities, services and advertisements whether answers to the quizzes are correct or not, and quiz answer related information notifying means 10H as eighth means for notifying the computer 11 of information relating to the answers to the quizzes.

Further, the above-mentioned information used herein relating to the answers to the quizzes includes information on commodities, services and advertisements relating to advertisements that a contestant saw, for example, information on a new commodity in addition to information on presentation of prizes, grant of points or the like. Each of these pieces of information is transmitted to the computer 11 of a party receiving information on commodities, services and advertisements from the computer 10 of a party providing advertisements by an e-mail based on data such as a mail address of the contestant.

In addition, the computer 10 is provided with questionnaire means 10I as ninth means for providing a questionnaire to the computer 11 of a party receiving information on advertisements and collecting answers to this questionnaire, and information analyzing means 10J as tenth means for analyzing information on commodities, services and advertisements that is obtained based on the answers to the questionnaire. Further, the corporations include nonprofit organizations, which include local self-governing bodies.

In addition, in the system for providing information, the computer 10 of a party providing information on commodities, services and advertisements provides information on commodities, services and advertisements of one or a plurality of corporations and also provides quizzes corresponding to the commodities, the services and the advertisements of the corporations. The computer 11 inputs answers of the quizzes and, at the same time, also inputs an identification number that identifies a contestant in the computer 10. Moreover, the computer 10 notifies the computer 11 of a party receiving information on advertisements whether the answers to the quizzes are correct or not and also notifies it of information relating to the answers of the quizzes. Further, the information relating to the answers to the quizzes includes information on commodities, services and advertisements relating to advertisements that a contestant of the quizzes saw.

In addition, the computer 10 of a party providing information on commodities, services and advertisements provides the quizzes to, for example, the computer 11 that is a terminal of a party receiving information on commodities, services and advertisements and provides a questionnaire to collect answers to the questionnaire. In the questionnaire, first quizzes are provided when the computer 11 of a party receiving information on commodities, services and advertisements accesses the computer 10 of a party providing information on commodities, services and advertisements, second quizzes are provided when advertisements provided by the computer 10 are clicked on the computer 11, third quizzes are provided when the computer 11 enters a contest for prizes provided by the computer 10, and the computer 10 thus collects answers to respective items in the questionnaire. Moreover, the computer 10 performs a predetermined data analysis based on the collected answers to the questionnaire.

In this system for providing information, the computer 10 of a party providing information on commodities, services and advertisements provides quizzes and also provides the questionnaire to the computer 11 that receives information. Then, the computer 10 collects answers to the questionnaire, analyzes the contents of the collected answers by the analysis engine (tenth means) 10J as information analyzing means, establishes a user database with high accuracy and provides the data to a provider of advertisements. Thus, effects of advertisements can further be improved. For example, the provider of advertisements can obtain samplings, statistics and the like of behaviors according to the contents of the answers to the quizzes based on the contents of the answers to the questionnaire, and can analyze and utilize them in business.

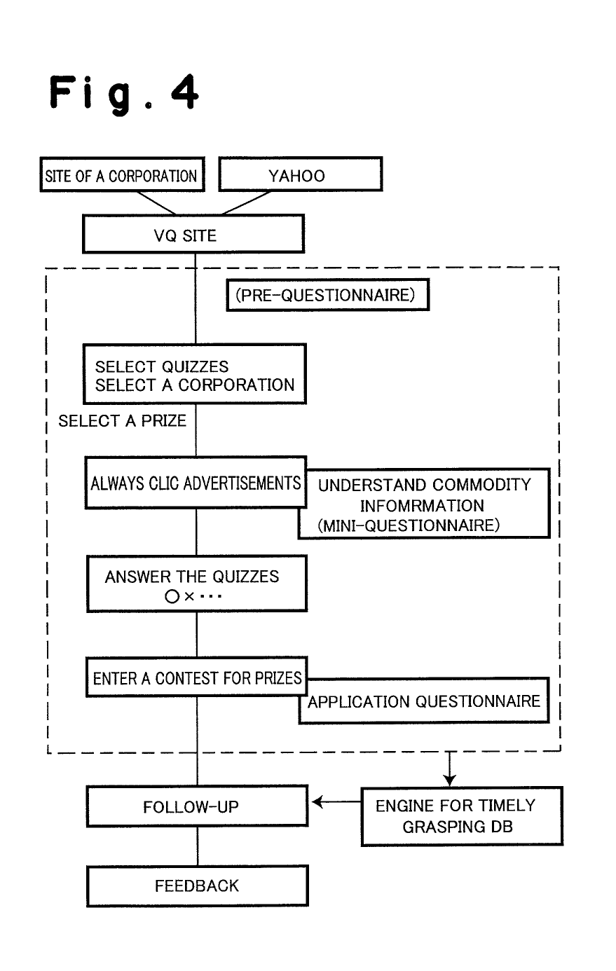

More specifically, as shown in FIG. 4, first quizzes are provided (pre-questionnaire) when the computer 11 accesses the computer 10 of a party providing information on commodities, services and advertisements, second quizzes are provided (mini-questionnaire) when advertisements provided by the computer 10 are clicked on the computer 11, third quizzes are provided (application questionnaire) when the computer 11 enters a contest for prizes provided by the computer 10, and the computer 10 thus collects answers to respective items of the questionnaire. In this way, an analysis with high accuracy becomes possible.

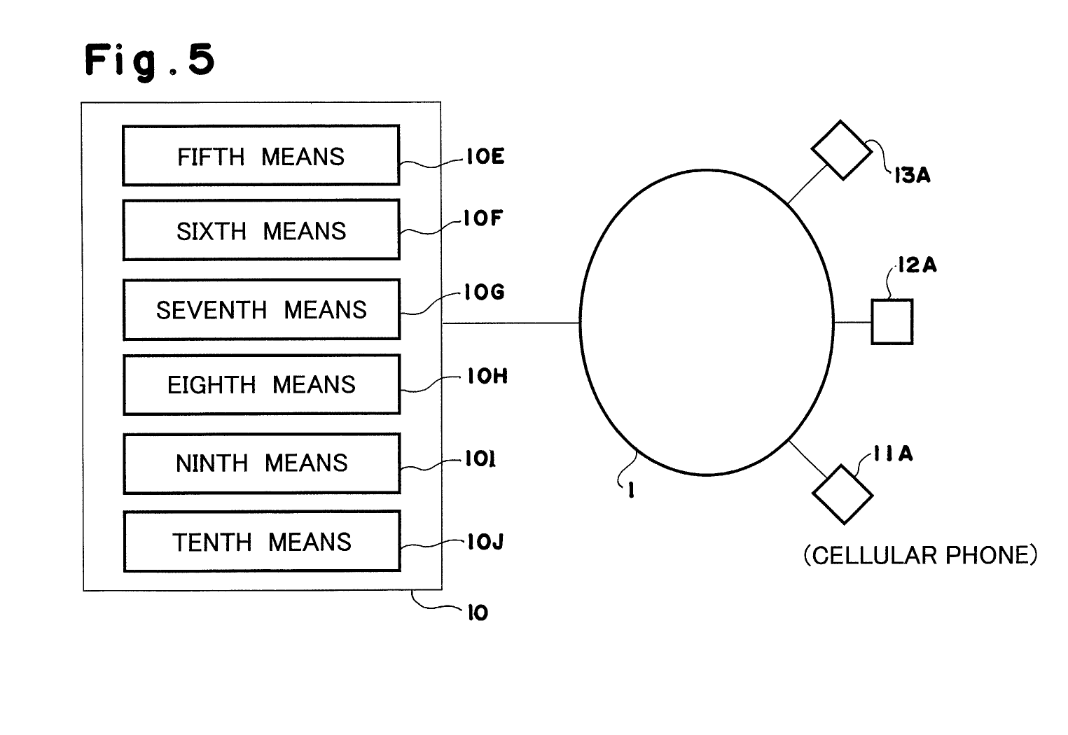

FIG. 5 shows still another embodiment of the present invention. Here, the computer 10 of a party providing information on commodities, services and advertisements and a plurality of cellular phones (terminals) 11A to 13A receiving information on commodities, services and advertisements are connected to the network 1. The computer 10 provides each piece of information on commodities, services and advertisements to the cellular phones 11A to 13A on the network 1. That is, the computer 10 providing information on commodities, services and advertisements provides advertisements of one or a plurality of corporations and also provides quizzes corresponding to the advertisements of the corporations. The cellular phones 11A to 13A receiving information on commodities, services and advertisements provide in turn input answers to the quizzes provided by the computer 10 providing information on commodities, services and advertisements and also input identification numbers that identify contestants.

In the aforementioned embodiments, the computers 11 to 13 connected to a network such as the Internet are used. On the other hand, in this embodiment, information on commodities, services and advertisements can be obtained by using a cellular phone that is capable of using, for example, the i-mode and the EZWeb.

As described above in detail, the following effects can be realized according to the present invention.

1. Contestants in quizzes (the aged, infants and children) can have intellectual amusements and improve health by entering quiz contests. Moreover, they have expectations that they may get prizes, and they can enjoy, for example, a merit (benefit) of purchasing commodities at discounted prices even if they are not chosen by lot. Therefore, people become active in participating in and entering quiz contests unlike the case in which they simply enter quiz contests.

2. On the other hand, images (impressions) and celebrity of advertisers being sponsors for providing quizzes are improved, and as a result, sales increase. In particular, it can be expected that tourists are attracted and invited at low costs in local self-governing bodies, which contributes to vitalization of the economies. In addition, marketing activities such as a market research can be performed efficiently and inexpensively. Moreover, since individual information of participants in the network can be easily collected, efficient sales promotion activities using data of such information also become possible.

3. Due to a simple configuration, the method and the system of the present invention have excellent characteristics such as in that they can be easily implemented. In addition, since quizzes are provided and a questionnaire is simultaneously provided according to the present invention, a user database with high accuracy can be established and effects of advertisements can be improved by reflecting results of the questionnaire in the advertisements.

Thus, it is seen that a method of providing information and a system using the method are provided. One skilled in the art will appreciate that the present invention can be practiced by other than the preferred embodiments which are presented for the purposes of illustration and not of limitation, and the present invention is limited only by the claims which follow.

What is claimed is:

1. A method of providing information with which a computer of a party providing information on commodities, services, advertisements and the like and a plurality of terminals of parties receiving information on commodities, services, advertisements and the like are connected to a network, and said computer of a party providing information provides information on commodities, services, advertisements and the like to said terminals of parties receiving information over said network, wherein
said computer of a party providing information provides advertisements of one or a plurality of corporations and also provides quizzes corresponding to said advertisements of said corporations, and said terminals of parties receiving information input answers to said quizzes provided by said computer of a party providing information and also input identification numbers for distinguishing contestants.

2. A method of providing information according to claim 1, wherein
said corporations include non-profit organizations.

3. A method of providing information according to claim 2, wherein
said non-profit organizations include local self-governing bodies.

4. A method of providing information according to claim 1, wherein
said computer of a party providing information notifies said terminals of parties receiving information whether said answers to said quizzes are correct or not.

5. A method of providing information according to claim 1, wherein
said computer of a party providing information provides information relating to said answers to said quizzes to said terminals of parties receiving information.

6. A method of providing information according to claim 5, wherein
said information relating to said answers to said quizzes includes information on commodities, services, advertisements and the like relating to advertisements that the contestants of said quizzes see.

7. A method of providing information according to claim 1, wherein
said computer of a party providing information provides said quizzes and, at the same time, provides a questionnaire to said terminals of parties receiving information, and collects answers to said questionnaire.

8. A method of providing information according to claim 7, wherein
in said questionnaire, first quizzes are provided when said terminals of parties receiving information access said computer of a party providing information, second quizzes are provided when advertisements provided by said computer of a party providing information are clicked on said terminals of parties receiving information, third quizzes are provided when said terminals of parties receiving information enter a contest for prizes provided by said computer of a party providing information, and said computer of a party providing information thus collects answers to respective items of said questionnaire.

9. A method of providing information according to claim 7 or 8, wherein
said computer of a party providing information performs predetermined data analysis based on said collected answers to said questionnaire.

10. A method of providing information according to any one of claims 1 to 9, wherein
said terminals are computers.

11. A method of providing information according to any one of claims 1 to 9, wherein said terminals are cellular phones.

12. A system for providing information with which a computer of a party providing information on commodities, services, advertisements and the like and a plurality of terminals of parties receiving information on commodities, services, advertisements and the like are connected to a network, and said computer of a party providing information provides information on commodities, services, advertisements and the like to said terminals of parties receiving information over said network, wherein
said computer of a party providing information is provided with fifth means for providing advertisements of one or a plurality of corporations and sixth means for providing quizzes corresponding to said advertisements of said corporations.

13. A system for providing information according to claim 12, wherein
said corporations include non-profit organizations.

14. A system for providing information according to claim 12, wherein
said non-profit organizations include local self-governing bodies.

15. A system for providing information according to any one of claims 12 to 14, wherein
said computer of a party providing information is provided with seventh means for notifying said terminals of parties receiving information whether said answers to said quizzes are correct or not.

16. A system for providing information according to any one of claims 12 to 15, wherein
said computer of a party providing information is provided with eighth means for notifying information relating to said answers to said quizzes to said terminals of parties receiving information.

17. A system for providing information according to claim 16, wherein
said information relating to said answers to said quizzes includes information on commodities, services, advertisements and the like relating to advertisements that the contestants of said quizzes see.

18. A system for providing information according to any one of claims 12 to 17, wherein
said computer of a party providing information is provided with ninth means for providing quizzes and, at the same time, providing a questionnaire to said terminals of parties receiving information, and collecting answers to said questionnaire.

19. A system for providing information according to claim 18, wherein
with said ninth means, first quizzes are provided when said terminals of parties receiving information access said computer of a party providing information, second quizzes are provided when advertisements provided by said computer of a party providing information are clicked on said terminals of parties receiving information, third quizzes are provided when said terminals of parties receiving information enter a contest for prizes provided by said computer of a party providing information, and said computer of a party providing information thus collects answers to respective items of said questionnaire.

20. A system for providing information according to claim 18 or 19, wherein
said computer of a party providing information is provided with tenth means for performing predetermined data analysis based on said collected answers to said questionnaire.

21. A system for providing information according to any one of claims 12 to 20, wherein
said terminals are computers.

22. A system for providing information according to any one of claims 12 to 20, wherein
said terminals are cellular phones.
